(19) United States
(12) Patent Application Publication
(10) Pub. No.: US 2018/0174066 A1
(43) Pub. Date: Jun. 21, 2018

(54) SYSTEM AND METHOD FOR PREDICTING STATE OF A PROJECT FOR A STAKEHOLDER

(71) Applicant: Wipro Limited, Bangalore (IN)

(72) Inventors: Arthi Venkataraman, Bangalore (IN); Swapnil Jariwala, Bangalore (IN)

(21) Appl. No.: 15/428,782

(22) Filed: Feb. 9, 2017

(30) Foreign Application Priority Data
Dec. 21, 2016 (IN) 201641043635

(51) Int. Cl. G06N 7/00; G06N 99/00

(52) U.S. Cl. CPC G06N 7/005; G06N 99/005

(57) ABSTRACT

Embodiment of the present disclosure discloses method and system for predicting a success rate of a project. The method comprises initiating a natural language conversation with stakeholder associated with project to determine one or more features relevant for the stakeholder. The one or more features are determined by performing Bayesian network analysis for one or more properties associated with project. The method comprises creating relationship structure, comprising one or more features, based on natural language processing of natural language conversation, wherein each of one or more features are assigned a score. The method comprises creating a prediction model with relative weightage values to each of one or more relevant features based on assigned score, wherein the prediction model is trained based on historic data associated with project and predicting success rate of project based on trained prediction model and current state of the project.

This application claims the benefit of Indian Patent Application Serial No. 201641043635, filed Dec. 21, 2016, which is hereby incorporated by reference in its entirety.

### TECHNICAL FIELD

The present subject matter is related in general to the field of project management, more particularly, but not exclusively to a method and system for predicting success rate of a project in real-time.

### BACKGROUND

A project is a unique, transient endeavour, undertaken to achieve planned objectives, which could be defined in terms of outputs or benefits for a company. Management of the project in a company includes application of processes, methods, knowledge, skills, and experience to achieve project objectives. Existing systems for managing a project include automated systems for determining state of the project, which may be success rate or failure rate associated with the project. Some of conventional systems for managing the project include determining state of the project based on historic data associated with the project. However, managing the project based on mere historic data or any other data associated with the project may not provide outcome as desired by a customer or stakeholder of that project.

The stakeholder of any project may be referred to be an individual, group, or organization, who may affect, be affected by, or perceive itself to be affected by a decision, activity, or outcome of that project. Any project may be associated with multiple stakeholders and preferences of each of the stakeholder for the project may differ. Existing system may consider to obtain required data from stakeholders and process the data to predict success rate of the project. The required data may be obtained by interacting with the stakeholders. These interactions may include predefined queries for which the customers provide their answers. These queries may not be dynamically generated based on the previous answer of the customer. When there may be multiple tasks within the project and each of these tasks have different parameters, the customer may have different priorities for different parameters. In this case, it is difficult to predict performance for different tasks and thereby determine the success rate of the project. In some scenarios, the preferences of the stakeholder may change and existing systems do not disclose to provision a dynamic interaction with the stakeholder to determine the changed preferences and generate appropriate queries to the stakeholder and further provide the success rate with respect to the preference of the stakeholder.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for predicting a success rate of a project in real-time. The method may comprise initiating a natural language conversation with a stakeholder associated with a project to determine one or more features relevant for the stakeholder. The one or more features may be determined by performing a Bayesian network analysis for one or more properties associated with the project. The method may comprise creating a relationship structure, comprising the one or more features, based on natural language processing of the natural language conversation. In an embodiment, each of the one or more features may be assigned a score. The method may further comprises creating a prediction model with relative weightage values to each of the one or more relevant features based on the assigned score. In an embodiment, the prediction model is trained based on the historic data associated with the project. The method further comprises predicting a success rate of the project based on the trained prediction model and a current state of the project.

In an embodiment, the present disclosure relates to a prediction system for predicting a success rate of a project in real-time. The predicting system may comprise a processor and a memory communicatively coupled to the processor. The memory stores processor executable instructions, which, on execution, may cause the predicting system to initiate a natural language conversation with a stakeholder associated with a project to determine one or more features relevant for the stakeholder. In an embodiment, the one or more features may be determined by performing a Bayesian network analysis for one or more properties associated with the project, create a relationship structure, comprising the one or more features, based on natural language processing of the natural language conversation. Each of the one or more features may be assigned a score. Further, a prediction model is created with relative weightage values to each of the one or more relevant features based on the assigned score. In an embodiment, the prediction model is trained based on the historic data associated with the project and predict a success rate of the project based on the trained prediction model and a current state of the project.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a and FIG. 1b illustrate exemplary environments for predicting success rate of a project in accordance with some embodiments of the present disclosure;

FIG. 2 shows a detailed block diagram of prediction system in accordance with some embodiments of the present disclosure;

FIG. 3 illustrates a flowchart showing a method for predicting success rate of a project in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method and a system for predicting success rate of a project in real-time. The present disclosure predicts the success rate based on one or more features provided by a stakeholder. System of the present disclosure interacts with the stakeholder to dynamically retrieve the one or more features and provide the predicted success rate to the stakeholder. The method includes initiating a natural language conversation with the stakeholder to determine the one or more features relevant for the stakeholder. The one or more features may be determined by performing a Bayesian network analysis for one or more properties associated with the project. Based on natural language processing of the natural language conversation, a relationship structure may be created. The relationship structure comprises the one or more features and the one or more features may be assigned a score. Further, a prediction model may be created with relative weightage values to each of the one or more relevant features based on the assigned score. The prediction model may be trained based on historic data associated with the project and the success rate may be predicted based on the trained prediction model and a current state of the project

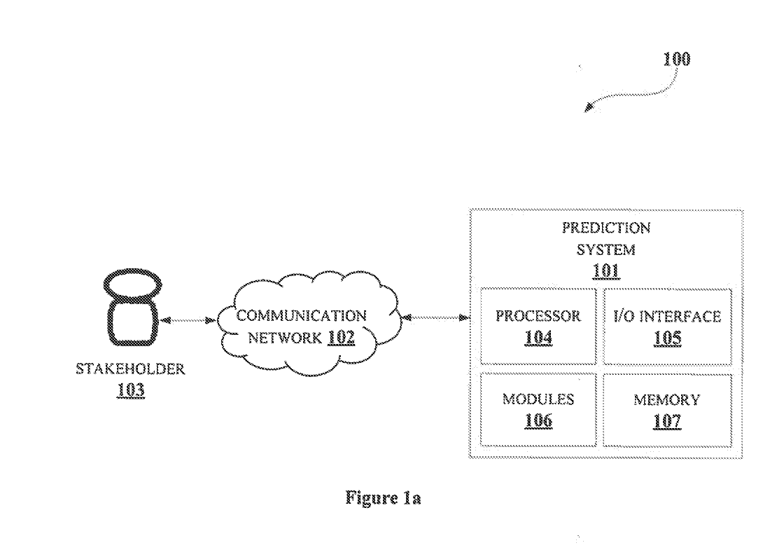

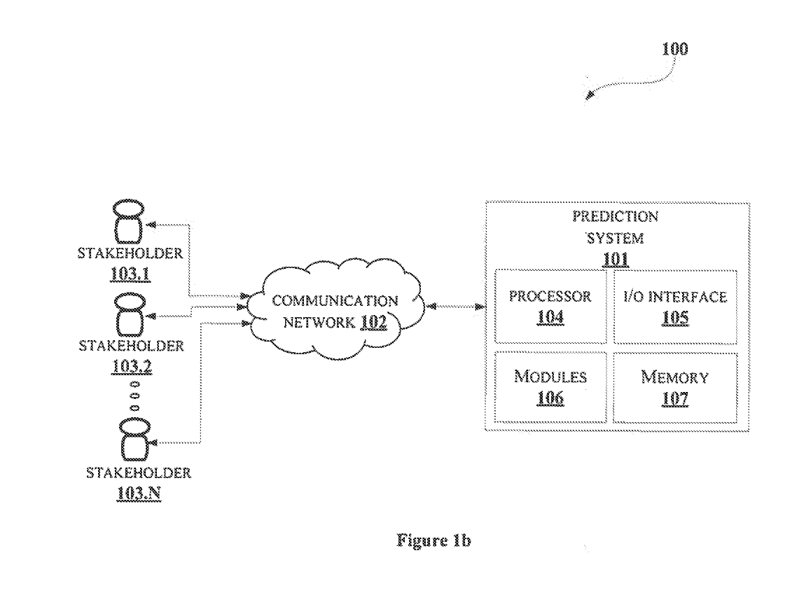

FIG. 1a and FIG. 1b illustrate exemplary environments for predicting success rate of a project in accordance with some embodiments of the present disclosure.

As shown in FIG. 1a, the environment 100 comprises a prediction system 101, a communication network 102 and a stakeholder 103 associated with a project for which a success rate may be determined. The stakeholder 103 of the project may be an individual, group, or organization who may be interested in the project. A person skilled in the art would understand that the stakeholder may be, but not limited to, a project leader, project team members, senior management, project customer, resource managers, line managers, product user group, project testers, any group impacted by the project as it progresses, any group impacted by the project when completed, subcontractors to the project and consultants to the project.

As shown in the FIGS. 1a and 1b, the stakeholder 103 may connect to the prediction system 101 through a communication network 102. The prediction system 101 may be configured to determine the success rate of the project. As shown in FIG. 1b, there may be one or more stakeholders 103.1-103.N (herewith, collectively referred to as the one or more stakeholder 103) associated with the project and may be connected to the prediction system 101 via the communication network 103 to obtain the success rate of the project. In an embodiment, the prediction system 101 may be configured to determine the success rate of one or more projects of the one or more stakeholders 103. The prediction system 101 may comprise a processor 104, an I/O interface 105, one or more modules 106 and memory 107. In some embodiment, the memory 107 communicatively coupled to the processor 104. The memory 107 stores processor executable instructions, which, on execution, may cause the predicting system 101 to predict the success rate of the project. The method of the prediction system 101 may comprise initiating a natural language conversation with the stakeholder 103 to determine one or more features relevant for the stakeholder 103. In an embodiment, a natural language conversation may be initiated for each of the one or more stakeholder 103 to determine the one or more features of the corresponding one or more stakeholders 103. The one or more features of the project may be prominent attributes associated with the project. The one or more features comprises one or more parameters associated with the project and priority details of the one or more parameters. Each of the one or more features may be associated with predefined one or more parameters. In an embodiment, the natural language conversation, for interacting with the stakeholder, may be associated with a dialog which may be displayed to the stakeholder to obtain the one or more features relevant to the stakeholder. The dialog may be configured to generate queries to the stakeholder 103 to receive said one or more features. In one embodiment, the interaction with the stakeholder, initially, may aim to retrieve priority details of the one or more features and further aim to retrieve priority details of the one or more parameters of each of the one or more features. Based on the priority details of the one or more features and the one or more parameters, relationship between the one or more parameters may be generated which may be a part of the one or more features retrieved from the stakeholder 103.

In the natural language conversation, the one or more features may be determined by performing a Bayesian network analysis on one or more properties associated with the project. Any person skilled in the art may understand that the Bayesian network is a type of probabilistic graphical model that represents a set of random variables and their conditional dependencies via a directed acyclic graph. The Bayesian network analysis of the project may be performed to achieve the natural language conversation with the stakeholder 103. The one or more properties may be prominent attributes associated with agent data and incident data of the project. In an embodiment, the natural language conversation may be determined by any other associated analysis known to the person skilled in art.

Based on natural language processing of the natural language conversation, a relationship structure which comprises the one or more features may be created. In an embodiment, the natural language processing may include processing of the one or more features. Specifically, the relationship structure comprises relationship between the one or more features and relationship between the one or more parameters of each of the one or more features. In case of one or more stakeholders 103, the relationship structure may be created for each of the one or more stakeholder. Further, each of the one or more features in the relationship structure may be assigned a score. The score of each of the one or more features may be based on the relationship between the one or more parameters of the corresponding one or more features. Based on the assigned score, a prediction model may be created with relative weightage values to each of the one or more relevant features. In case of one or more stakeholders 103, the prediction model may be created for each of the one or more stakeholder. In an exemplary embodiment, the prediction model may be trained based on the historic data associated with the project. In an embodiment, the prediction model may be a logistic regression model. Based on the trained prediction model and a current state of the project, the success rate of the project may be predicted. In an embodiment, the success rate may be different of each of the one or more stakeholders, in an embodiment, the processor may be further configured to determine factors affecting the success rate of the project.

The I/O interface of the prediction system may be configured to receive and transmit data, stored in the memory 107, associated for predicted the success score. In an embodiment, the memory 107 may be outside the prediction system for predicting the success rate.

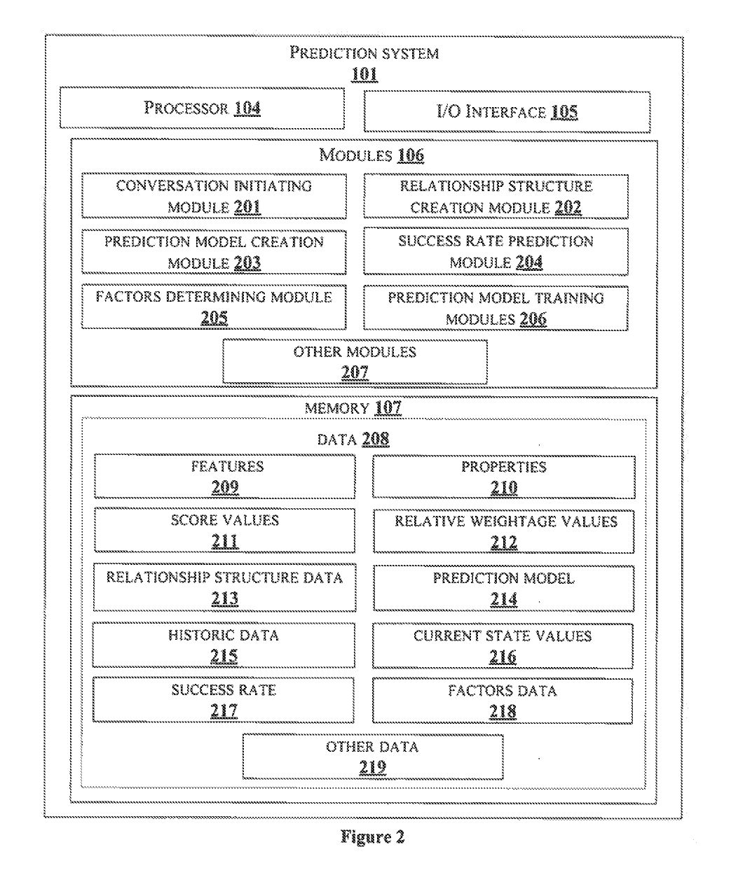

FIG. 2 shows a detailed block diagram of the prediction system 101 in accordance with some embodiments of the present disclosure. Data 207 in the memory 107 and one or more modules 106 of the prediction system 101 may be described herein in detail.

In one implementation, the one or more modules 106 may include, but may not limited to, a conversation initiating module 201, a relationship structure creation module 202, a prediction model creation module 203, a success rate prediction module 204, a factors determining module 205, a prediction model training module 206 and one or more other modules 207 associated with the prediction system 101.

In an embodiment, data 208 in the memory 107 comprises one or more features 207, one or more properties 208, score values 211 (may be referred as the scores 211), relative weightage values 212, relationship structure data 213 (may be referred as the relationship structure 213), the prediction model 214, the historic data 215, current state values (also referred as the current state 216), the success rate 217, factors data (also referred as the factors 218) and other data 219 associated with the prediction module.

In an embodiment, the data 208 in the memory 107 may be processed by the one or more modules 106 of the prediction system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules when configured with the functionality defined in the present disclosure will result in a novel hardware.

The conversation initiating module 201 initiates the natural language conversation with the stakeholder 103 to determine the one or more features 209 relevant for the stakeholder 103. The one or more features 209 of the project may be prominent attributes associated with the project. Any person skilled in the art may understand that one or more features 209 may include, but not limited to, schedule, cost, scope, collaboration, documentation, and resource. Further, the one or more features 209 may comprise the one or more parameters associated with the project and relationship between the one or more parameters. Each of the one or more features 209 may be associated with predefined one or more parameters. For example, if schedule may be feature selected by the stakeholder 103, the one or more parameters may be, but not limited to, agent load, agent score, issue complexity, elapsed time since open and so on. Each of the one or more features 209 may be associated with predefined one or more parameters. As described in an embodiment, the natural language conversation for interacting with the stakeholder 103 may be associated with a dialog which may be displayed to the stakeholder 103 to obtain the one or more features 209 relevant to the stakeholder. The dialog may be configured to generate queries to the stakeholder 103 to receive said one or more features 209. In an embodiment, the queries generated may depend on information received from the stakeholder 103 for the previous query. For example, initially, the query for the stakeholder 103 may be to select at least of the one or more features 209 with high priority. If the stakeholder 103 selects the schedule as highest priority, the queries relating to the one or more parameters associated with the schedule may be generated. The next query to the stakeholder 103 may be “How important may be agent load on a scale of 1 to 3 where 1 means not important, 2 means moderately important, 3 means very important?”. Now, the stakeholder 103 may provide inputs for this query in the dialog. If the stakeholder 103 inputs the scale to be 2, based on the natural language processing of the query and the input, value of 2 may be extracted and stored for the parameter agent load. Similarly, inputs for each of the one or more parameters may be provided to the corresponding queries in the dialog.

In an embodiment, the prediction system 101 may also provide a provision to the stakeholder 103 to input additional one or more parameters associated with each of the one or more features 209. The query may be “Do you wish to add any additional parameters?”, if the stakeholder 103 inputs as yes, further query may be generated which may be “What is the additional parameter?”. The stakeholder 103 may provide the additional one or more parameters as an input for that query. Upon receiving the additional one or more parameters, the prediction system 101 may be configured to generate further queries relating to the additional one or more parameters. For example, the queries relating to the one or more additional parameters may be “Share the details of this parameter”, “What is the priority of this parameter?” and so on. In an embodiment, the additional one or more parameters may be stored in the prediction system 101 for further predictions.

The natural language conversation with the stakeholder 103 may be achieved by Bayesian network analysis of the one or more properties 210. The one or more properties 210 may be prominent attributes associated with an agent data and incident data of the project. The agent data may comprise properties associated with one or more agents of the project. Any person skilled in the art may understand that the one or more agents may be responsible for managing the project. The agent data may be, but not limited to, agent ID, agent experience, performance score and so on. The incident data may comprise properties associated with incidents of each the one or more parameters. The incident data may be, but not limited to incident ID, incident status, time taken to resolve, agent ID of agent who resolved, times reopened and so on.

The relationship structure creation module 202 creates the relationship structure 213 which comprises the one or more features 209, based on the natural language processing of the natural language conversation. In an embodiment, the natural language processing may include processing of the one or more features 209 obtained from the stakeholder 103. Specifically, the relationship structure 213 comprises relationship between the one or more features 209 and relationship between the one or more parameters of each of the one or more features 209. Further, each of the one or more features 209 in the relationship structure 213 may be assigned a score 211.

Below table illustrates an example for assigning the score 211 for the one or more parameters of the corresponding one or more features 209.

Example of how the values are obtained for the features in Table 1:

TABLE 1

| Feature | Score |
|---|---|
| agent load | 2 |
| agent score | 3 |
| issue complexity | 3 |
| elapsed time since open | 1 |
| Number of times re- | 2 |
| opened | |

From the table, based on the score 211 assigned to each of the one or more parameters, the elapsed time since open may no longer be relevant and the agent score and the issue complexity may be of highest priority. In an embodiment, a conditional independence reasoning may be implemented in the prediction system 101 for ignoring the one or more parameters which are non-relevant.

The prediction model creation module 203 may create the prediction model 214 with relative weightage values 212 to each of the one or more features 209 based on the assigned score 211 for the one or more parameters associated with each of the one or more features 209. In an embodiment, the prediction model 214 may be a logistic regression model. In another embodiment, the prediction model 214 may be Naives Bayes, Support Vector Machine (SVM) regression and other associated algorithms for predicting the success rate 217. In an embodiment. The relative weightage values 212 may be obtained based on the interaction with the stakeholder 130.

The prediction model training model 206 may be configured to train the prediction model 214 based on the historic data 215. The historic data 215 may be extracted using connectors which connect to one or more enterprise systems associated with the project. In an embodiment, the connectors may be software modules through which said historic data 215 may be extracted. In an embodiment, one or more enterprise systems may include ticketing systems, incident management systems and project management systems.

The success rate prediction module 204, based on the trained prediction model 214 and the current state 216 of the project, may predict the success rate 217 of the project.

For example, consider the stakeholder selects the schedule and the cost with the schedule as first priority and the cost as second priority. A score combiner logic associated with the success rate prediction module 204 may be as given in equation 1.

relative weight of schedule*score of schedule+relative weight of cost*score of cost 1

In an embodiment, consider the relative weight of schedule is 0.8 and relative weight of cost is 0.2. If score of schedule is 0 and the score of cost is 1 then score for the success rate may be 0.2. If score of schedule is 1 and score of cost is 0 then score is 0.8 and if score of schedule is 1 and score of schedule cost is 1 then the score is 1. Here, 0 indicates failure of the one or more features and 1 indicates success of the one or more features.

Factors determining module 205, determines the factors 218 affecting the success rate 217 of the project. The factors 218 may be one or more aspect of the project responsible for one of success and failure of the project. For example, consider Table 1, which illustrates score 211 assigned to the one or more parameters when the schedule from the one or more features 209 is of highest priority to the stakeholder 103. In the table, the agent score and the issue complexity are assigned highest score and hence may be most important amongst other features. Consider, for the said example, the prediction model 214 may predict the success rate 217 to be lesser a predefined threshold, then it is understood that there may be schedule deviation. On analysis of the one or more parameters, the factors 218 may be determined to be issue was not complex and agent is less skilled, since the agent score and the issue complexity are assigned the highest score.

The other data 219 may store data, including temporary data and temporary files, generated by modules for performing the various functions of the prediction system 101. The one or more modules 106 may also comprise other modules 207 to perform various miscellaneous functionalities of the prediction system. It will be appreciated that such modules may be represented as a single module or a combination of different modules.

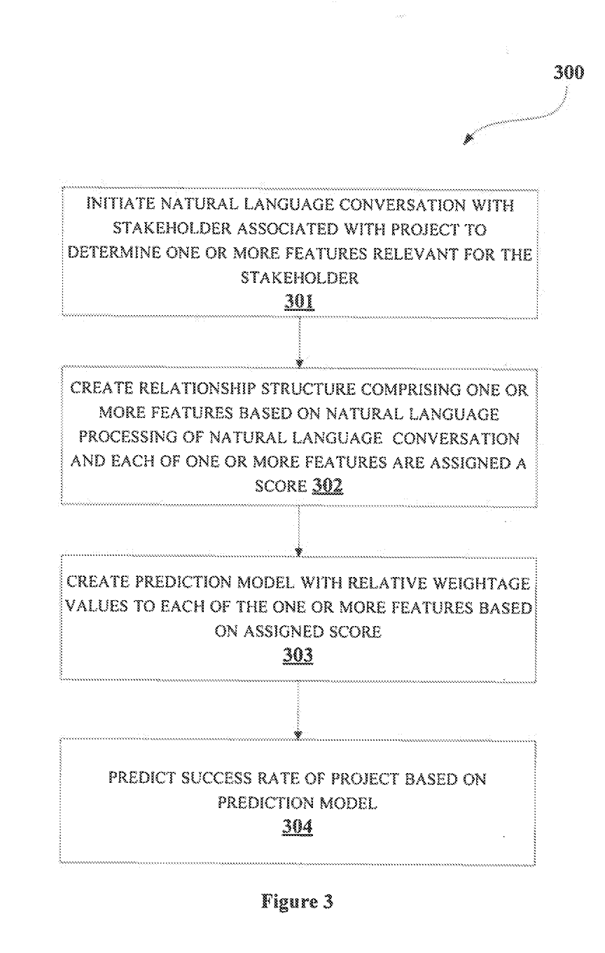

FIG. 3 illustrates a flowchart showing the method for predicting the success rate 217 of the project in accordance with some embodiments of present disclosure.

As illustrated in FIG. 3, the method 300 comprises one or more blocks for executing processes in the prediction system 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the natural language conversation may be initiated, by the conversation initiating module 201, with the stakeholder 103 associated with the project to determine the one or more features 209 relevant for the stakeholder 103. The one or more features 209 may be determined by performing the Bayesian network analysis for the one or more properties 210 associated with the project.

At block 302, the relationship structure creation model 202 creates the relationship structure 213 which comprises the one or more features 209. The relationship structure 213 may be created based on the natural language processing of the natural language conversation. Further, each of the one or more features 209 may be assigned a score 211.

At block 303, the prediction model creation module 203 creates the prediction model 214 with relative weightage values 212 to each of the one or more relevant features 209 based on the assigned score 211. Also, the prediction model 101 may be trained based on the historic data 215 associated with the project.

At block 404 the success rate prediction module 204 predicts the success rate 217 of the project based on the trained prediction model 214 and the current state 216 of the project.

### Computing System

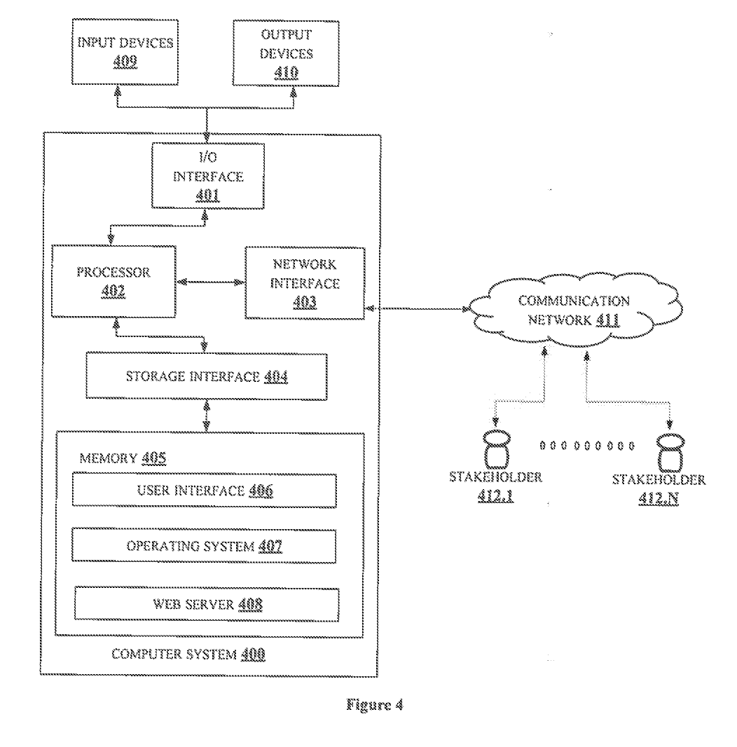

FIG. 4 illustrates a block diagram of an exemplary computer system 400 for implementing embodiments consistent with the present disclosure. In an embodiment, the computer system 400 is used to implement the Virtual Storage Area Network 102. The computer system 400 may comprise a central processing unit (“CPU” or “processor”) 402. The processor 402 may comprise at least one data processor for executing processes in Virtual Storage Area Network. The processor 402 may include specialized processing units such as, integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 consists of a process execution server 101. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with one or more stake holders 412.1-412.N for predicting success rate of a project. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407 etc. In some embodiments, computer system 400 may store user/application data 406, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure disclosed an efficient method to dynamically predict success rate of a project based on preference of a stakeholder associated with project.

An embodiment of present disclosure provides dynamic configuration of project success priorities based on stakeholder preference.

An embodiment of present disclosure provides automated important feature extractions relevant for a project.

An embodiment of present disclosure provides re-creation of prediction models including one or more features used as well as algorithm based on inputs of stakeholder.

An embodiment of the present disclosure provisions prediction of a success rate of a project for multiple stakeholders associated with the project.

An embodiment of the present disclosure provisions prediction is success rates for multiple projects for a stakeholder.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for predicting a success rate of a project in real-time, comprising:
initiating, by a prediction computing device, a natural language conversation with a stakeholder associated with a project to determine one or more features relevant for the stakeholder, wherein the one or more features are determined by performing a Bayesian network analysis of one or more properties associated with the project.
creating, by the prediction computing device, a relationship structure, comprising the one or more features, based on natural language processing of the natural language conversation, wherein each of the one or more features are assigned a score;
creating, by the prediction computing device, a prediction model with relative weightage values to each of the one or more relevant features based on the assigned score, wherein the prediction model is trained based on a historic data associated with the project; and
predicting, by the prediction computing device, a success rate of the project based on the trained prediction model and a current state of the project.

2. The method as claimed in claim 1, further comprising determining factors affecting the success rate of the project.

3. The method as claimed in claim 1, wherein the one or more features comprises one or more parameters associated with the project and priority details of the one or more parameters.

4. The method as claimed in claim 3, wherein the score of each of the one or more features is based on the relationship between the one or more parameters of the corresponding one or more features.

5. The method as claimed in claim 1, wherein the prediction model is a logistic regression model.

6. A prediction computing device comprising:
a processor; and
a memory communicatively coupled to the processor, wherein the memory stores processor-executable instructions, which, on execution, cause the processor to:
initiate a natural language conversation with a stakeholder associated with a project to determine one or more features relevant for the stakeholder, wherein the one or more features are determined by performing a Bayesian network analysis of one or more properties associated with the project;
create a relationship structure, comprising the one or more features, based on natural language processing of the natural language conversation, wherein each of the one or more features are assigned a score;
create a prediction model with relative weightage values to each of the one or more relevant features based on the assigned score, wherein the prediction model is trained based on a historic data associated with the project; and
predict a success rate of the project based on the trained prediction model and a current state of the project.

7. The device as claimed in claim 6, wherein the processor is further configured to determine factors affecting the success rate of the project.

8. The device as claimed in claim 6, wherein the one or more features comprises one or more parameters associated with the project and priority details of the one or more parameters.

9. The device as claimed in claim 8, wherein the score of each of the one or more features is based on the relationship between the one or more parameters of the corresponding one or more features.

10. The device as claimed in claim 6, wherein the prediction model is a logistic regression model.

11. A non-transitory computer readable medium having stored thereon instructions for predicting a success rate of a project in real-time comprising executable code which when executed by a processor, causes the processor to:
initiate a natural language conversation with a stakeholder associated with a project to determine one or more features relevant for the stakeholder, wherein the one or more features are determined by performing a Bayesian network analysis of one or more properties associated with the project;
create a relationship structure, comprising the one or more features, based on natural language processing of the natural language conversation, wherein each of the one or more features are assigned a score;
create a prediction model with relative weightage values to each of the one or more relevant features based on the assigned score, wherein the prediction model is trained based on a historic data associated with the project; and
predict a success rate of the project based on the trained prediction model and a current state of the project.

12. The medium as set forth in claim 11 further comprising determine factors affecting the success rate of the project.

13. The medium as set forth in claim 11 wherein the one or more features comprises one or more parameters associated with the project and priority details of the one or more parameters.

14. The medium as set forth in claim 11 wherein the score of each of the one or more features is based on the relationship between the one or more parameters of the corresponding one or more features.

15. The medium as set forth in claim 11 wherein the prediction model is a logistic regression model.
